(19) United States
(12) Patent Application Publication
(10) Pub. No.: US 2025/0307586 A1
(43) Pub. Date: Oct. 2, 2025

(54) IMAGE PROCESSING METHOD, IMAGE PROCESSING DEVICE, PRINTING SYSTEM, AND IMAGE PROCESSING PROGRAM

(71) Applicant: SEIKO EPSON CORPORATION, Tokyo (JP)

(72) Inventors: Takuya ONO, SHIOJIRI-SHI (JP); Takahiro KAMADA, MATSUMOTO-SHI (JP); Mitsuhiro YAMASHITA, MATSUMOTO-SHI (JP); Yuko YAMAMOTO, SHIOJIRI-SHI (JP)

(21) Appl. No.: 19/090,817

(22) Filed: Mar. 26, 2025

(30) Foreign Application Priority Data
Mar. 28, 2024 (JP) 2024-053775

(51) Int. Cl. G06K 15/02; B41J 3/46; G06K 15/00; G06T 19/20

(52) U.S. Cl. CPC G06K 15/1882; B41J 3/46; G06K 15/002; G06K 15/1859; G06T 19/20; G06K 2215/101; G06T 2219/2016

(57) ABSTRACT

The image processing method includes (a) receiving the stacking order of the print medium and one or more print layers, (b) displaying a preview image representing a state in which one or more virtual three dimensional objects corresponding to one or more print layers and the three dimensional object printed on the print medium are superimposed and combined, the preview image corresponding to how the preview image appears in a three dimensional virtual space, (c) displaying the preview image representing a state in which one or more three dimensional objects corresponding to one or more print layers and the three dimensional object printed on the print medium are stacked in the stacking order with intervals between them, the preview image corresponding to how the preview image appears in the virtual space, (d) receiving an instruction to execute one of (b) and (c), and executing the instructed one of (b) and (c).

The present application is based on, and claims priority from JP Application Serial Number 2024-053775, filed Mar. 28, 2024, the disclosure of which is hereby incorporated by reference herein in its entirety.

### BACKGROUND

### 1. Technical Field

The present disclosure relates to an image processing method, an image processing device, a printing system, and an image processing program.

### 2. Related Art

JP-A-2017-159552 describes a technique of displaying, when printing is executed on a transparent medium, preview images that simulate the printed matter resulting from the printing process.

In the technique described in JP-A-2017-159552, since a preview image in a two dimensional space is displayed, it is difficult to grasp a non-print region, which is a region of the transparent medium where no image is formed. Further, when a plurality of print layers is formed, it is difficult to grasp each print layer. For this reason, there has been a demand for a technique that enables a user to easily grasp each print layer.

### SUMMARY

The present disclosure can be implemented as the following aspects.

According to a first aspect of the present disclosure, an image processing method is provided. The image processing method includes a step (a) of receiving a stacking order of a print medium and one or more print layers to be stacked on the print medium by printing on the print medium; a step (b) of displaying a preview image on a display device, the preview image representing a state of one or more virtual three dimensional objects that correspond to the one or more print layers and a three dimensional object that corresponds to the print medium superimposed and combined in the stacking order, the preview image corresponding to appearance in a three dimensional virtual space; a step (c) of displaying a preview image on the display device, the preview image representing the state of the one or more three dimensional objects corresponding to the one or more print layers and the three dimensional object corresponding to the print medium stacked in the stacking order with intervals therebetween, the preview image corresponding to appearance in the virtual space; and a step (d) for receiving an instruction to execute one of step (b) and step (c), and executing the instructed one of step (b) and step (c).

According to a second aspect of the present disclosure, an image processing device is provided. The image processing device includes a print setting reception section that receives a stacking order of a print medium and one or more print layers to be printed on a print medium and a display processing section that configured to display, on a display device, a preview image representing one or more virtual three dimensional objects representing printed matter, the preview image corresponding to an appearance in a three dimensional virtual space. In accordance with an instruction received relating to display mode, the display processing section displays, on the display device, the preview image representing the one or more three dimensional objects corresponding to the one or more print layer layers and a state of the three dimensional objects superimposed and combined in the stacking order with respect to the print medium, the preview image corresponding to how the preview image appears in a three dimensional virtual space or displays, on the display device, the preview image representing the one or more three dimensional objects corresponding to the one or more print layers and the state of the three dimensional objects stacked in the stacking order with intervals between them with respect to the print medium, the preview image corresponding to how the preview image appears in the virtual space.

According to a third aspect of the present disclosure, a printing system is provided. The printing system includes an image processing device, a printing device, and a display device. The image processing device includes a print setting reception section that receives a stacking order of a print medium and one or more print layers to be printed on a print medium and a display processing section configured to display, on the display device, a preview image representing one or more virtual three dimensional objects representing printed matter, the preview image corresponding to how the printed matter appears in a three dimensional virtual space. In accordance with an instruction received relating to display mode, the display processing section displays, on the display device, the preview image representing the one or more three dimensional objects corresponding to the one or more print layer layers and a state of the three dimensional objects superimposed and combined in the stacking order with respect to the print medium, the preview image corresponding to how the preview image appears in a three dimensional virtual space or displays, on the display device, the preview image representing the one or more three dimensional objects corresponding to the one or more print layers and the state of the three dimensional objects stacked in the stacking order with intervals between them with respect to the print medium, the preview image corresponding to how the preview image appears in the virtual space.

According to a fourth aspect of the present disclosure, a non-transitory computer-readable storage medium storing an image processing program is provided. The image processing program causes a computer to realize the following functions, a function (a) for receiving a stacking order of a print medium and one or more print layers to be printed on a print medium; a function (b) for displaying, on a display device, a preview image representing one or more virtual three dimensional objects corresponding to one or more print layers and a state of the three dimensional objects superimposed and combined in the stacking order with respect to the print medium, the preview image corresponding to how the preview image appears in a three dimensional virtual space; a function (c) for displaying, on the display device, the preview image representing the one or more three dimensional objects corresponding to the one or more print layers and the state of the three dimensional objects stacked in the stacking order with intervals between them with respect to the print medium, the preview image corresponding to how the preview image appears in the virtual space; and a function (d) for receiving an instruction to execute one of the function (b) and the function (c), and executing the instructed one of the function (b) and the function (c).

### BRIEF DESCRIPTION OF THE DRAWINGS

FIG. 1 shows a block diagram illustrating a schematic configuration of a printing system according to an embodiment.

FIG. 2 is an explanatory diagram illustrating an example of printed matter in which an image is printed on a transparent print medium.

FIG. 3 is an explanatory diagram illustrating another example of printed matter in which an image is printed on a transparent print medium.

FIG. 4 is an explanatory diagram of a printed matter PT3.

FIG. 5 is an explanatory diagram of printed matter PT4.

FIG. 6 is an explanatory diagram of a printed matter PT5.

FIG. 7 is an explanatory diagram of a printed matter PT6.

FIG. 8 is an explanatory diagram of a printed matter PT7.

FIG. 9 is an explanatory diagram showing a configuration of the image processing device.

FIG. 10 is an explanatory diagram showing a processing content of the CMS.

FIG. 11 is an explanatory diagram showing flow of a color conversion process.

FIG. 12 is an explanatory diagram showing a configuration of a rendering section.

FIG. 13 is a flowchart illustrating a process related to the printing process executed in the image processing device.

FIG. 14 is an explanatory diagram showing an example of a user interface for inputting image data.

FIG. 15 is an explanatory diagram schematically showing a state in which the front side of a printed matter represented as a 3D object in the virtual space is observed.

FIG. 16 is an explanatory diagram schematically illustrating a state in which the rear side of the printed matter represented as a 3D object in the virtual space is observed.

FIG. 17 is an explanatory diagram of a user interface on which a preview image is displayed.

FIG. 18 is a flowchart showing a switching process of a preview image display.

FIG. 19 is an explanatory diagram showing the user interface in a state in which a preview image representing the expanded printed matter is displayed in a display region.

FIG. 20 is an explanatory diagram showing an example of a display mode of a preview image according to an other embodiment 1.

FIG. 21 is an explanatory diagram illustrating another example of a display mode of a preview image according to the other embodiment 1.

FIG. 22 is an explanatory diagram of a user interface according to an other embodiment 2.

FIG. 23 is an explanatory diagram of a user interface according to an other embodiment 3.

FIG. 24 is an explanatory diagram of an operation of a user interface UI according to an other embodiment 4.

### DESCRIPTION OF EMBODIMENTS

### A. Embodiments

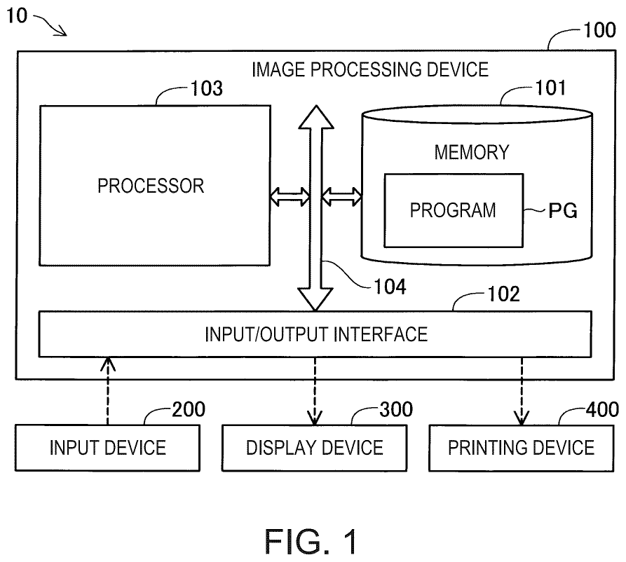

FIG. 1 shows a block diagram illustrating a schematic configuration of a printing system 10 according to the present embodiment. The printing system 10 includes an image processing device 100, an input device 200, a display device 300, and at least one printing device 400. The printing system 10 functions as a printing device in a broad sense.

The image processing device 100 generates a rendering image corresponding to the appearance of printed matter in a three dimensional virtual space by physical based rendering (hereinafter simply referred to as rendering). The image processing device 100 causes the display device 300 to display the generated rendering image as the preview image before execution of printing. In present embodiment, the appearance of the printed matter in the three-dimensional virtual space is defined by the position and orientation of a three dimensional object (hereinafter referred to as a 3D object) in the virtual space, or the viewpoint position and viewing direction of the user with respect to the 3D object in the virtual space.

The printing device 400 is an inkjet type printing device and directly prints an image on a print medium. In the present embodiment, the printing device 400 prints an image on a transparent print medium. The print medium has a flat plate shape. As the print medium, a transparent film or sheet made of materials such as polypropylene (PP), polyethylene (PE), or polyvinyl chloride (PVC) can be used. As the print medium, a transparent plate formed of materials such as acrylic or glass can be used. However, the print medium may be translucent. The transparent print medium may be a medium that has an average transmittance of visible light of 80% or more, for example. The translucent print medium may be a medium that has an average visible light transmittance of 30% or more and less than 80%, for example. In present embodiment, processing will be described for the case where a transparent print medium is used. Substantially the same processing can be applied to both the case of using a translucent print medium and the case of using an opaque print medium.

The printing device 400 can perform rear side printing in addition to front side printing. Front side printing refers to printing on the front side of a print medium. In the present disclosure, the front side of the print medium refers to a surface on the side on which the printed matter is assumed to be observed. The rear side is a surface opposite to the front side. Rear side printing refers to printing on the rear side of a transparent print medium with the orientation of the image and the order of overprint reversed. The rear side printed image is visible through the transparent print medium. By rear side printing, printed matter with transparency or gloss can be obtained. Some examples of front side printing and rear side printing will be described below.

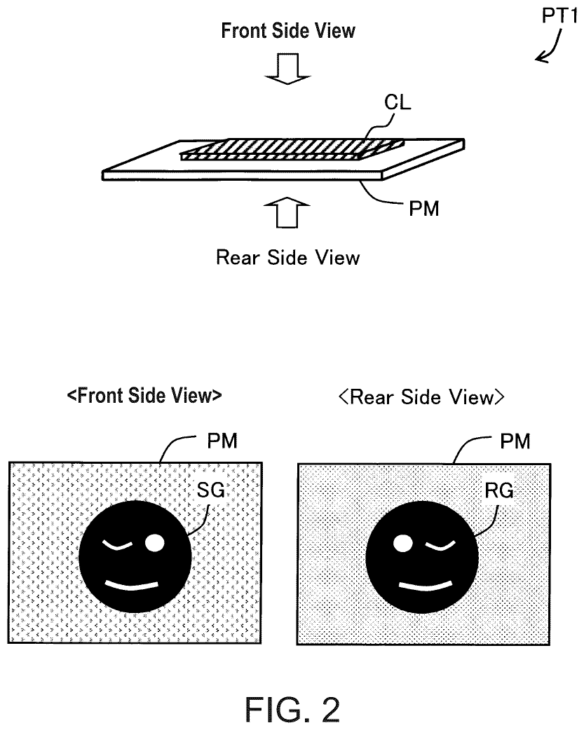

FIG. 2 is an explanatory diagram illustrating the example of a printed matter PT1 in which an image is printed on a transparent print medium. With respect to the printed matter PT1, a color layer CL, on which a front side image SG is formed, is formed on the front side of a transparent print medium PM. The printed matter PT1 is printed by front side printing. The color layer CL is formed by the printing of plates for each color of the process colors. The color layer CL is formed by a set of process ink dots. The thicknesses of the layers are exaggerated for convenience of illustration. The printed matter PT1 is assumed to be observed only from the front side, but when observed from the rear side, the rear side image RG, which is a horizontally inverted image of the front side image SG, can be seen. The horizontally inverted image is also referred to as a mirror-inversion image.

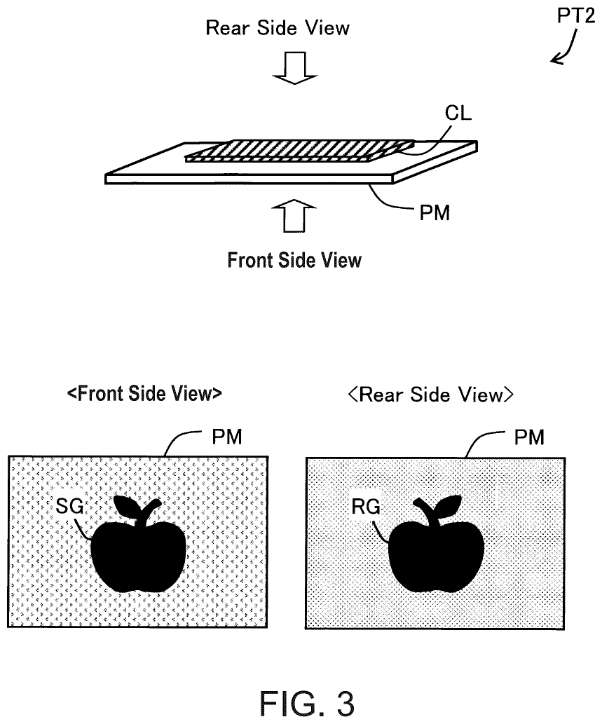

FIG. 3 is an explanatory diagram illustrating another example of printed matter in which an image is printed on a transparent print medium. In FIG. 3, the thicknesses of the layers are exaggerated for convenience of illustration.

In printed matter PT2, a color layer CL forming a rear side image RG is printed on the rear side of a transparent print medium PM. The printed matter PT2 is printed by rear side printing. FIG. 3 shows a state in which the printed matter PT2 is arranged such that the rear side of the print medium PM is positioned on the upper side. Since the print medium PM is transparent, when observed from the front side, the front side image SG, which is a horizontally inverted image of the rear side image RG, is seen through the print medium PM.

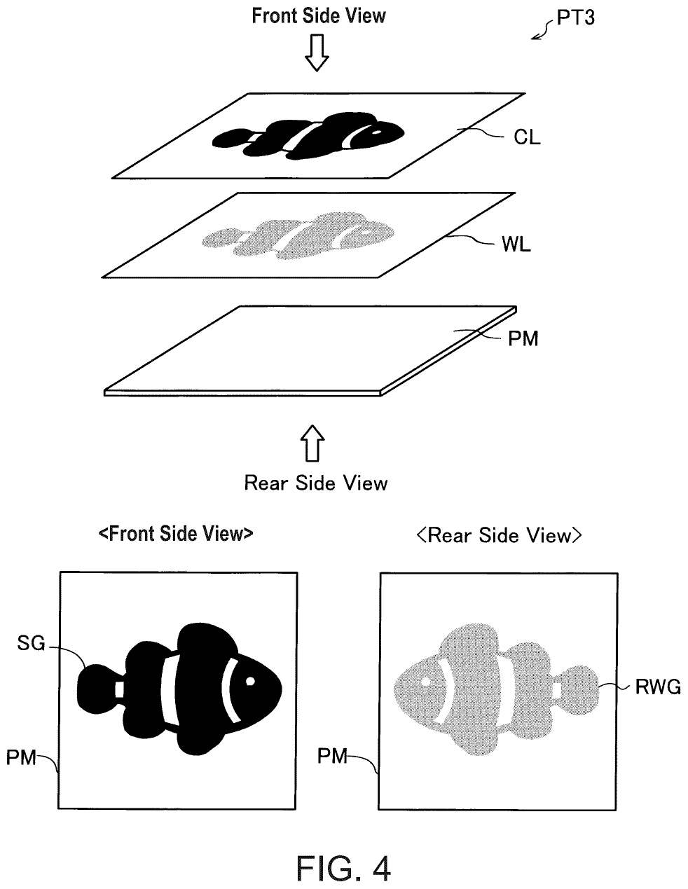

FIG. 4 is an explanatory diagram of a printed matter PT3 printed on a transparent print medium PM by front side printing. The undercoat layer WL, which is formed by the undercoat ink, and the color layer CL are laminated on the front side of the print medium PM in this order, starting from the side closest to the front side of the print medium PM. The undercoat layer WL is an undercoat for the color layer CL. The color layer and the undercoat layer together are referred to as a print layer. The print layer may be simply referred to as a layer. The printed matter PT3 is assumed to be observed only from the front side. When observed from the front side, the front side image SG is visible. When observed from the rear side, an undercoat region RWG is visible. The undercoat region RWG formed by the undercoat layer WL has a shape corresponding to a horizontally inverted image of the front side image SG.

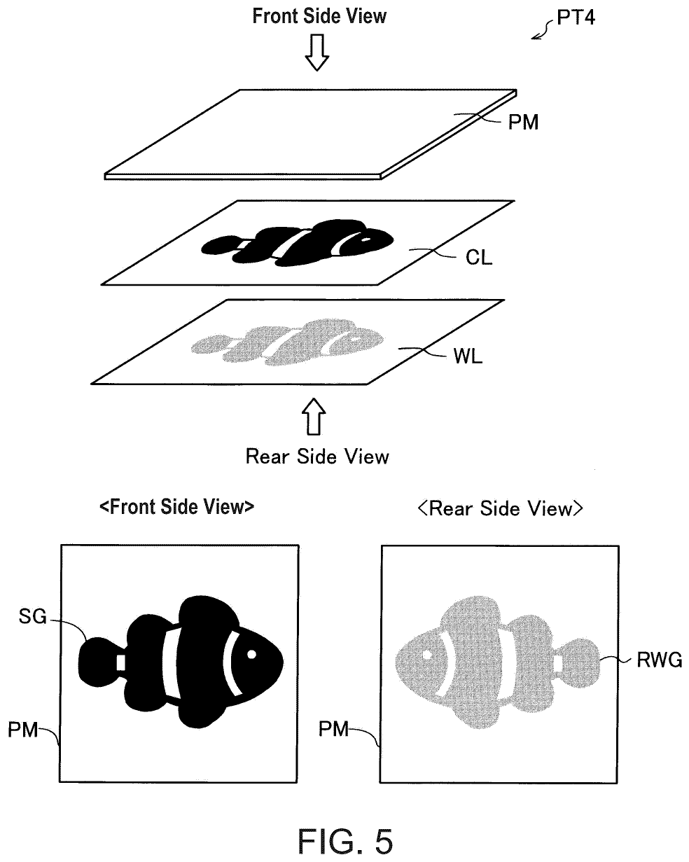

FIG. 5 is an explanatory diagram of a printed matter PT4 printed on the transparent print medium PM by rear side printing. The color layer CL and the undercoat layer WL are laminated on the rear side of the print medium PM in this order, starting from the side closest to the rear side of the print medium PM. The undercoat layer WL is an undercoat for the color layer CL. It is assumed that the printed matter PT4 is observed only from the front side. When observed from the front side, the front side image SG is visible. When observed from the rear side, an undercoat region RWG is visible. The undercoat region RWG formed by the undercoat layer WL has a shape corresponding to a horizontally inverted image of the front side image SG.

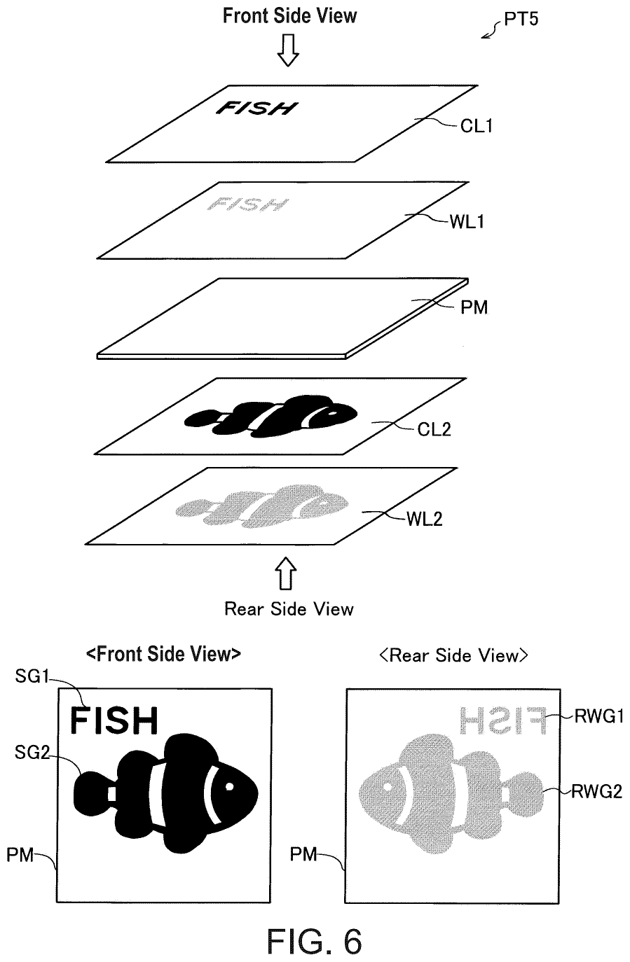

FIG. 6 is an explanatory diagram of a printed matter PT5 in which images are printed on both surfaces of the transparent print medium PM. The undercoat layer WL1 and the color layer CL1 are laminated on the front side of the print medium PM in this order, starting from the front side of the print medium PM. The color layer CL1 and the undercoat layer WL1 are formed by front side printing. The color layer CL2 and the undercoat layer WL2 are laminated on the rear side of the print medium PM in this order, starting from the side closest to the rear side of the print medium PM. The color layer CL2 and the undercoat layer WL2 are formed by rear side printing. The printed matter PT5 is assumed to be observed only from the front side. When observed from the front side, the front side image SG1 and the front side image SG2 are seen. When observed from the rear side, the undercoat region RWG1 and the undercoat region RWG2 are visible. When observed from the rear side, the undercoat region RWG1 formed by the undercoat layer WL1 has a shape corresponding to a horizontally inverted image of the front side image SG1. The undercoat region RWG2 formed by the undercoat layer WL2 has a shape corresponding to the horizontally inverted image of the front side image SG2.

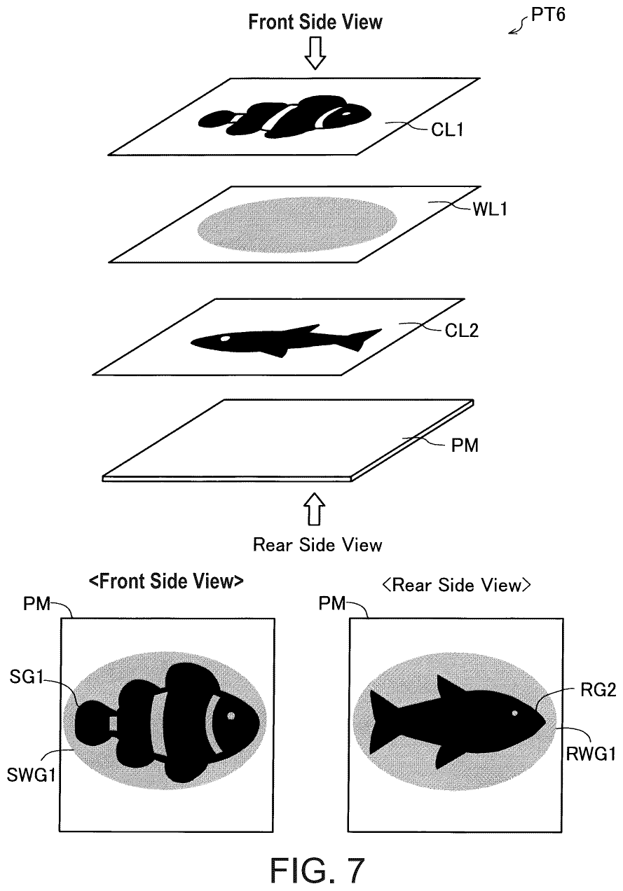

FIG. 7 is an explanatory diagram of printed matter PT6 in which an image is printed on one side of a transparent print medium PM. The color layer CL2, the undercoat layer WL1, and the color layer CL1 are laminated on the front side of the print medium PM in this order, starting from the side closest to the front side of the print medium PM. In the printed matter PT6, all layers are formed using front side printing. The undercoat layer WL1 is the undercoat for the color layer CL1 and the color layer CL2. The undercoat layer WL1 is formed in an elliptical shape that completely includes the front side image SG1 formed by the color layer CL1 and the rear side image RG1 formed by the color layer CL2. The printed matter PT6 is assumed to be observed from the front side and the rear side. When observed from the front side, the front side image SG1 and the undercoat region SWG1 are visible. When observed from the rear side, the rear side image RG2 and the undercoat region RWG1 are seen. The rear side image RG2 cannot be seen from the front side, and the front side image SG1 cannot be seen from the rear side.

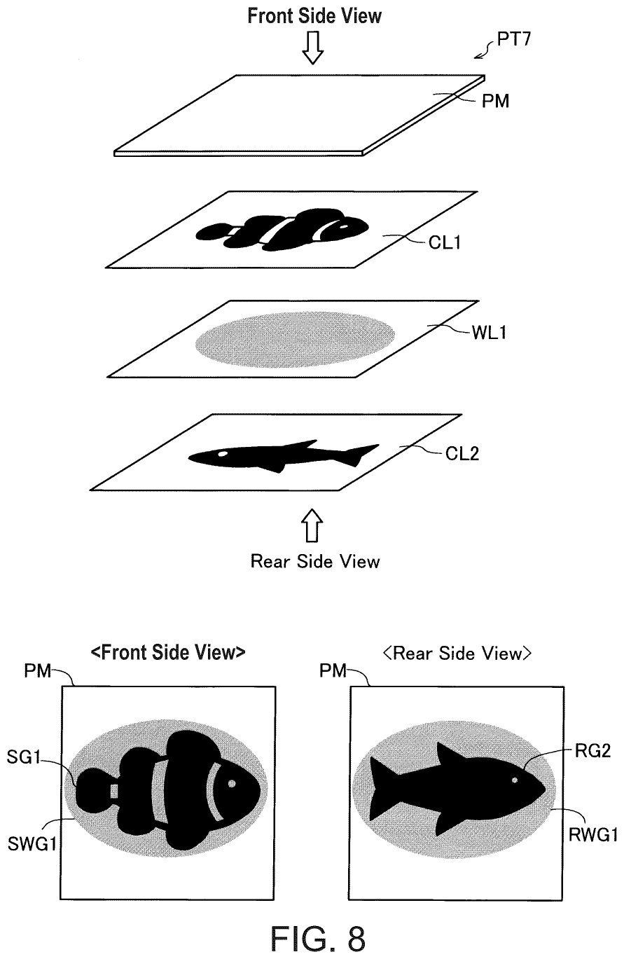

FIG. 8 is an explanatory diagram of a printed matter PT7. In the printed matter PT6 shown in FIG. 7, all the layers are formed on the front side of the print medium PM by front side printing, whereas in the printed matter PT7 shown in FIG. 8, all the layers are formed on the rear side of the print medium PM by rear side printing. The color layer CL1, the undercoat layer WL1, and the color layer CL2 are laminated on the rear side of the print medium PM in this order, starting from the side closest to the rear side of the print medium PM. The undercoat layer WL1 is the undercoat for the color layer CL1 and the color layer CL2. The undercoat layer WL1 is formed in an elliptical shape that completely includes the front side image SG1 configured by the color layer CL1 and the rear side image RG1 formed by the color layer CL2. The printed matter PT7 is assumed to be observed from the front side and the rear side. When observed from the front side, the front side image SG1 and the undercoat region SWG1 are visible. When observed from the rear side, the rear side image RG2 and the undercoat region RWG1 are visible. The rear side image RG2 cannot be seen from the front side, and the front side image SG1 cannot be seen from the rear side.

The printed matter PT6 shown in FIG. 7 and the printed matter PT7 shown in FIG. 8 have in common that a front side image SG1 representing an anemonefish can be seen from the front side, and a rear side image RG2 representing a shark can be seen from the back side. However, since the printed matter PT6 and the printed matter PT7 differ in the side on which the print layer is formed, the rear side image RG2 representing the shark can be seen through the print medium PT in the printed matter PT6, whereas the front side image SG1 representing the anemonefish can be seen through the print medium PT in printed matter PT7.

As illustrated in FIG. 1, the image processing device 100 is a computer including a memory 101, an input/output interface 102, a processor 103, and an internal bus 104. The memory 101, the input/output interface 102, and the processor 103 are communicably coupled via the internal bus 104. The memory 101 stores various programs and various data used for various processes executed by the image processing device 100. A program PG is stored in the memory 101. The input device 200, the display device 300, and the printing device 400 are coupled to the input/output interface 102 by wired communication or wireless communication. The processor 103 realizes various functions by executing the program stored in the memory 101. The input device 200 is, for example, a keyboard or a mouse. The display device 300 is, for example, a liquid crystal display or an organic electro luminescence (EL) display. In the present embodiment, the display device 300 further includes a function as a pointing device.

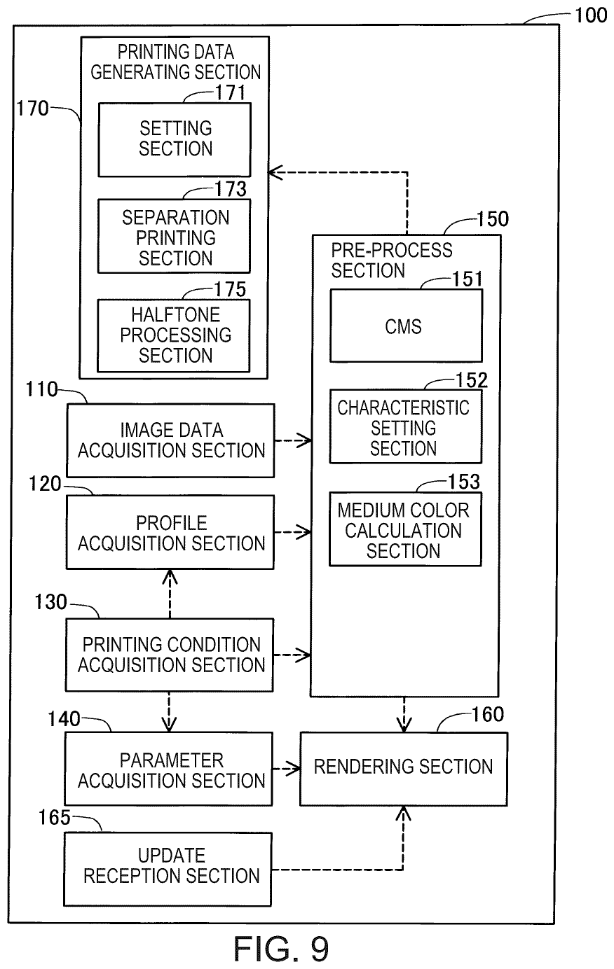

FIG. 9 is an explanatory diagram showing configuration of the image processing device 100. The image processing device 100 includes an image data acquisition section 110, a profile acquisition section 120, a printing condition acquisition section 130, a parameter acquisition section 140, a pre-process section 150, a rendering section 160, an update reception section 165, and a print data generating section 170. The functions of these units are realized by the processor 103 executing the program PG stored in the memory 101 illustrated in FIG. 1. The rendering section 160 is also referred to as a “display processing section”.

The image data acquisition section 110 acquires image data selected by a user via a user interface UI (to be described later). The selected image data is referred to as input image data IMi. The input image data IMi represents an image to be formed on a print medium. The input image data IMi is sent to the pre-process section 150.

The profile acquisition section 120 acquires an input profile IPF, a media profile MPF, and a common color space profile CPF stored in advance in the memory 101. In FIG. 1, illustration of the input profile IPF, the media profile MPF, and the common color space profile CPF is omitted. The input profile IPF, the media profile MPF, and the common color space profile CPF are used for color conversion by a color management system 151 of the pre-process section 150 (to be described later). Details of each profile will be described later. Each acquired profile is sent to the pre-process section 150. Note that the profile acquisition section 120 may acquire each profile from an external server via a network (not shown).

The printing condition acquisition section 130 acquires printing conditions. The printing conditions include conditions such as the type of print medium, the type of printing, the stacking order indicating the order in which the print medium and one or more print layers are stacked, the type of ink of the print layer, the resolution of printing, and the type of printing device. When the print medium has a flat plate shape, the stacking order refers to an order in which the print medium and one or more print layers are laminated with the front side of the print medium facing upward. The printing conditions acquired by the printing condition acquisition section 130 are sent to the profile acquisition section 120, the pre-process section 150, and the parameter acquisition section 140. The printing condition acquisition section 130 is also referred to as a “print setting reception section”.

The parameter acquisition section 140 acquires various parameters used for rendering from the memory 101. Various parameters are stored in the memory 101 in advance. The various parameters used for rendering include, for example, 3D object information, camera information, lighting information, and medium parameters. The 3D object information is a parameter relating to the shape of the print medium arranged in the virtual space as the 3D object. The camera information is a parameter related to the position and orientation of the camera arranged in the virtual space. The lighting information consists of parameters related to the type of light source arranged in the virtual space, the position and direction of the light source, the color, and the luminous intensity (quantity of light). The types of light sources include, for example, fluorescent lamps and incandescent bulbs.

The print medium parameter is a parameter related to the texture of the print medium. In the present embodiment, the medium parameter includes a texture parameter representing the texture of the print medium and a translucency parameter representing the translucency of the print medium. The texture parameters include, for example, a base color relating to the base color of the print medium, smoothness representing the smoothness of the print medium, metallic representing the metallic property of the print medium, a normal line map, and a height map. When the metallic property is high, surrounding scenery is likely to be reflected on the print medium. Each of the texture parameters may include roughness representing the roughness of the print medium instead of smoothness. The normal line map and the height map are used to represent minute unevenness of the print medium that affects the reflection of light. The normal line map is a texture representing a distribution of normal line vectors of a minute uneven surface. The height map is a texture representing the distribution of the height of the minute uneven surface. When the size of the polygons constituting the 3D object is reduced to represent minute unevenness, the number of polygons becomes enormous, and the computational load of rendering increases. By using the normal line map and the height map, it is possible to express the influence of the minute uneven surface on the reflection of light without reducing the size of the polygon. The translucency parameter includes a medium transmittance representing the transmittance (transparency) of light of the print medium. The translucency parameter may include a medium opacity representing the opaque degree (opacity) of the print medium.

The various parameters acquired by the parameter acquisition section 140 are sent to the rendering section 160. Note that the parameter acquisition section 140 may acquire various parameters from an external server via a network (not shown).

The pre-process section 150 includes the color management system 151, a specific color setting section 152, and a medium color calculation section 153. Hereinafter, the color management system 151 may be simply referred to as CMS 151.

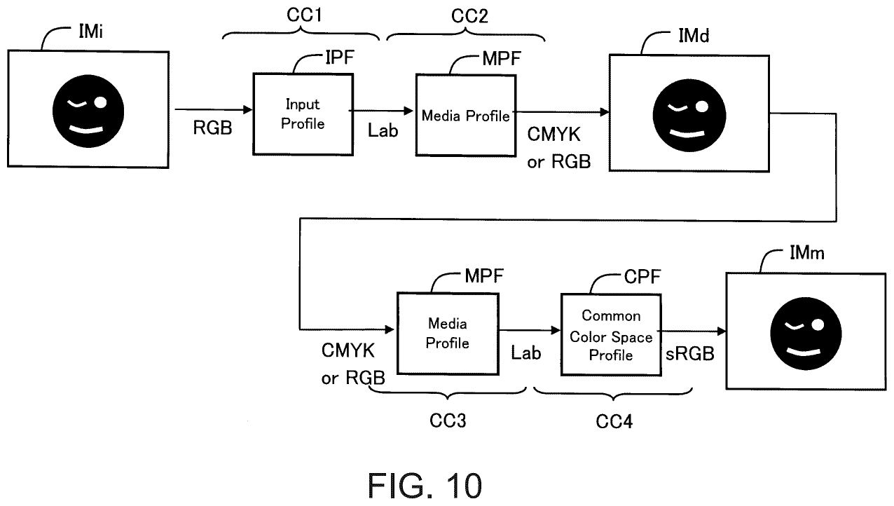

FIG. 10 is an explanatory diagram showing the processing contents of the CMS 151. The CMS 151 executes various kinds of color conversion processing using each profile acquired by the profile acquisition section 120.

The input profile IPF is an international color consortium (ICC) profile used for color conversion from a color space (input color space) of image data to a device-independent color space. The input color space is, for example, an RGB color space. The device-independent color space is, for example, the CIE-L*a*b* color space. The media profile MPF is an ICC profile used for color conversion from a device-independent color space to a device-dependent color space for the printing device 400. The device-dependent color space for the printing device 400 is, for example, a CMYK color space. The color of the device-dependent color space for the printing device 400 is also referred to as a device color. The common color space profile is an ICC profile used for color conversion from a device-independent color space to a color space for rendering. The color space for rendering is, for example, sRGB, Adobe RGB, and Display-P3.

An example of the color conversion processing executed by the CMS 151 is as follows. The CMS 151 sequentially performs the following color conversion processing for the input image data IMi.

(1) A first color conversion CC1 from an input color space to a device-independent space using an input profile IPF.

(2) A second color conversion CC2 from the device-independent color space to the device-dependent color space for the printing device 400 using the media profile MPF.

(3) A third color conversion CC3 from the device-dependent color space for the printing device 400 to the device-independent color space using the media profile MPF.

(4) A fourth color conversion CC4 from the device-independent color space to the rendering color space using the common color space profile CPF.

Through the first color conversion CC1 and the second color conversion CC2, the color values of the image data are converted into a range that can be represented by printing. In other words, by the first color conversion CC1 and the second color conversion CC2, the color value of the image data is converted into the color value of the color space depending on the printing device and the print medium. The image data subjected to the first color conversion CC1 and the second color conversion CC2 is referred to as device color image data IMd. The device color image data IMd is sent to the print data generating section 170 (see FIG. 9). For example, since images are printed on both surfaces of the print medium PM, plural sets of input image data IMi may be input. In this case, plural sets of device color image data IMd are obtained by the color conversion process for each input image data IMi.

As shown in FIG. 10, by the third color conversion CC3 and the fourth color conversion CC4, the color value of the image data is converted into a range that can be represented by rendering. By performing the first color conversion CC1 to the fourth color conversion CC4, the color value of the image data is converted into the color value of the rendering color space. The image data converted into the color value of the rendering color space is referred to as rendering image data IMm. The rendering image data IMm is used as a texture to be added to a polygon representing the color layer CL in rendering. The RGBA values of the base colors of the color layer CL are set to (1, 1, 1, 1). The rendering image data IMm is sent to the rendering section 160. In addition, for example, since images are printed on both surfaces of the print medium PM, plural sets of input image data IMi may be input. In this case, plural sets of rendering image data IMm are obtained by the color conversion process for each set of input image data IMi.

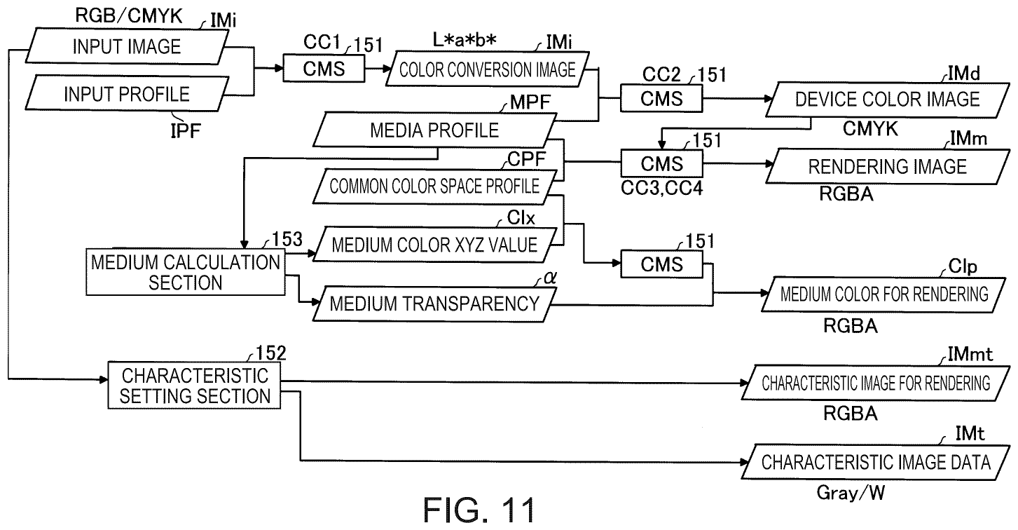

FIG. 11 is an explanatory diagram showing flow of a color conversion process. In FIG. 11, for convenience of description, a plurality of CMS 151 is illustrated, but these are the same CMS 151.

The specific color setting section 152 generates specific color image data IMt and rendering specific color image data IMmt. The specific color image data IMt is image data for printing the undercoat layer WL. The rendering specific color image data IMmt is image data obtained by converting the specific color image data IMt into a color value of the rendering color space. As shown in FIGS. 2 and 3, when the undercoat layer WL is not formed, it is not necessary to generate the specific color image data IMt and the rendering specific color image data IMmt.

For example, as shown in FIG. 4, when the undercoat region formed by the undercoat layer WL has the same shape as the image formed by the color layer CL, first, the specific color setting section 152 determines the region occupied by the image, which is the region printed by the process ink, from the value of each pixel of the input image data IMi. A region occupied by an image to be printed means the region composed of pixels having substantial colors, that is, pixels in which R=G=B=1 is not satisfied. The specific color setting section 152 generates specific color image data IMt by performing expansion processing on the front side image SG. The specific color image data IMt indicates a region in which the undercoat ink is printed to form the undercoat layer WL. The specific color image data IMt is used to create a specific color plate for printing the undercoat ink. The color space of the specific color image data IMt is a device-dependent color space for the printing device 400. The specific color image data IMt is a grayscale image composed of only white. The specific color image data IMt is sent to the print data generating section 170. As shown in FIG. 4, when the undercoat layer WL is formed on substantially the entire rear side of the print medium PM, the specific color setting section 152 generates the specific color image data IMt indicating that the undercoat layer WL is formed on the entire rear side.

Further, the specific color setting section 152 converts the specific color image data IMt into an image for rendering, thereby generating rendering specific color image data IMmt. The rendering specific color image data IMmt is used as a texture to be added to polygons representing the undercoat layer WL in rendering. In the present embodiment, since white ink is used to print the undercoat layer WL, the specific color setting section 152 sets, for example, (1, 1, 1, 1) as the RGBA value of the base color of the undercoat layer WL. The rendering specific color image data IMmt is sent to the rendering section 160.

As shown in FIG. 11, the medium color calculation section 153 acquires XYZ values representing the color of the print medium PM from the media profile MPF. In the media profile MPF, the XYZ values representing the color of the print medium PM are stored in advance. The CMS 151 uses the common color space profile CPF to convert the XYZ value Clx representing the colors of the print medium PM into RGB values. Further, the medium color calculation section 153 acquires the medium transparency αindicating the transmittance (transparency) of light of the print medium. The medium transparency is included in the medium parameter acquired by the parameter acquisition section 140. The medium color calculation section 153 combines the medium transmittance α together with the RGB value obtained by converting the XYZ value Clx that represents the color of the print medium PM and outputs it as an RGBA value that represents the rendering medium color Clp to the rendering section 160.

The rendering section 160 illustrated in FIG. 9 generates a rendering image representing how a print medium on which an image is printed looks in a virtual space. In rendering process, the printed matter is represented as a 3D object in a virtual space. As will be described in detail later, the rendering section 160 updates the display of the rendering image displayed on the user interface UI when an operation instruction from the user is received.

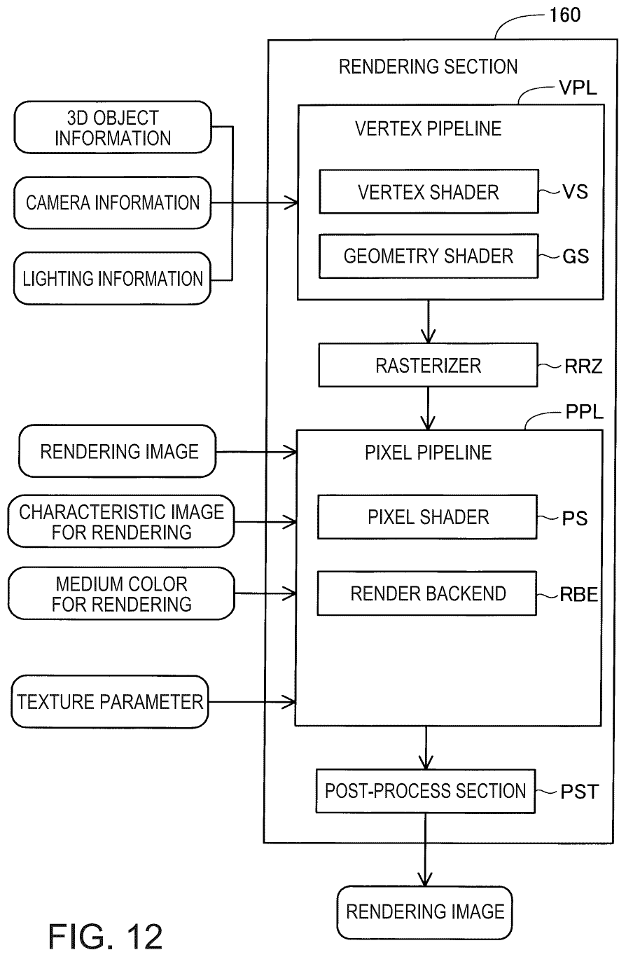

FIG. 12 is an explanatory diagram showing a configuration of the rendering section 160. The rendering section 160 employs a pipeline configuration including a vertex pipeline VPL, a rasterizer RRZ, a pixel pipeline PPL, and a post-process section. The vertex pipeline VPL comprises a vertex shader VS and a geometry shader GS. The pixel pipeline PPL comprises a pixel shader PS and a render backend RBE.

The vertex shader VS uses the 3D object information, camera information, and lighting information to execute processing related to polygons constituting the 3D object. This processing includes coordinate conversion of the vertices of each polygon constituting the 3D object, calculation of normal line vectors of each polygon, shading processing, calculation of texture-mapping coordinates (UV coordinates), and the like. The coordinate conversion includes model conversion, which is the coordinate conversion from the local coordinate system of the 3D object to the world coordinate system, view conversion, which is the coordinate conversion from the world coordinate system to the view coordinate system, and projective conversion, which is the coordinate conversion from the view coordinate system to the screen coordinate system. Some of the coordinate conversions described above may be performed by the geometry shader GS. The processing result of the vertex shader VS is sent to the geometry shader GS.

The geometry shader GS processes a set of vertices of the 3D object. The geometry shader GS can convert polygons into points and lines by increasing or decreasing the number of vertices and can convert points or lines into polygons. The processing result of the geometry shader GS is sent to the rasterizer RRZ. The geometry shader GS may not be provided in the rendering section 160. In this case, the processing result of the vertex shader VS is sent to the rasterizer RRZ.

The rasterizer RRZ generates drawing information for each pixel from the processing result of the vertex pipeline VPL by executing rasterization processing. The processing result of the rasterizer RRZ is sent to the pixel shader PS.

The pixel shader PS performs a lighting process using the rasterized 3D object, the image data, and the texture parameter to calculate the color of the front side polygon and the rear side polygon corresponding to each pixel. As a function for calculating reflection of light in the lighting processing, for example, Disney-principled bidirectional reflectance distribution function (BRDF) can be used. The processing result of the pixel shader PS is sent to the render backend RBE.

The render backend RBE determines whether to write the pixel data generated by the pixel shader PS to the display region of the memory 101. If the render backend RBE judges to write to memory 101, the pixel data is stored as a render target, and if the render backend RBE does not judge to write to memory 101, the pixel data is not stored as a render target. For example, an alpha test, a depth test, a stencil test, or the like is used to determine whether or not to write. In the present embodiment, the pixel data includes color information of the front side polygon and color information of the rear side polygon. The render backend RBE writes the colors of the polygon objects in order from those farthest from the camera to the nearest, for example, by using a depth sorting method. When the render backend RBE writes the color of the polygon on the front side after writing the color of the polygon object on the back side, the render backend RBE synthesizes the color of the polygon object on the back side and the color of the polygon on the front side in accordance with the transmittance of the polygon on the front side by, for example, alpha blending. If the transmittance is zero, when the color of the polygon on the front side is written, the color of the polygon on the back side is overwritten with the color of the polygon on the front side. Such a process of writing to the display region is also referred to as a “drawing process”. When the pixel data is written into memory 101, the pipeline processing is completed.

The post-process section PST performs post-processing such as anti-aliasing, ambient occlusion, screen space reflection, and depth of field processing on the rendering image formed of the pixel data stored in memory 101. The post-processing can improve the appearance of the rendering image.

The update reception section 165 illustrated in FIG. 9 receives an instruction to update the display of the rendering image representing printed matter represented as the 3D object in the virtual space. To be specific, the update reception section 165 receives a change instruction to change the appearance of the 3D object in a rendering image as the preview image displayed on a user interface UI (to be described later). The update reception section 165 outputs the received change instruction to the rendering section 160.

The print data generating section 170 generates print data to be supplied to the printing device 400. The print data generating section 170 includes a setting section 171, a separation printing section 173, and a halftone processing section 175.

The setting section 171 determines whether or not the horizontal inversion process of the image to be printed is necessary according to the printing condition. More specifically, when “rear side printing” is selected as the type of printing, the setting section 171 determines that the image to be printed needs to be subjected to the horizontal inversion process. In a case where “front side printing” is selected as the type of printing, the setting section 171 determines that the horizontal inversion process is not necessary for the image to be printed.

When the horizontal inversion process is necessary, that is, when rear side printing is designated, the setting section 171 executes the horizontal inversion process of the device color image data IMd obtained by the color conversion process of CMS 151. On the other hand, when front side printing is designated, the inversion processing is not executed.

The setting section 171 determines the order in which the print layers are laminated. Specifically, the arrangement position (arrangement surface) at which the print layer is arranged with respect to the print medium and the stacking order in which the plurality of print layers is stacked in a case where the number of print layers is plural are determined according to the printing condition. When “Yes” is selected for the undercoat layer existence, the number of print layers is two, namely the color layer and the undercoat layer. When “No” is selected for the undercoat layer existence, the number of print layers is one color layer. When “rear side printing” is selected as the type of printing, the arrangement positions of respective layers are the rear side of the print medium. In a case where “front side printing” is selected as the type of printing, the arrangement positions of respective layers are the front side of the print medium.

For example, when “rear side printing” and “presence” of the undercoat layer are selected as the type of printing, it is determined that the color layer and the undercoat layer are superimposed in this order on the rear side of the print medium. When “front side printing” and “presence” of the undercoat layer are selected as the type of printing, it is determined that the undercoat layer and the color layer are superimposed in this order on the front side of the print medium.

The separation printing section 173 converts the output value of each pixel of the device color image data IMd that was subjected to horizontal inversion processing or that was not subjected to horizontal inversion processing, into a density value of a plurality of color materials of the printing device 400. In the present embodiment, the separation printing section 173 converts the output value CMYK of each pixel of the device color image data IMd into a density value of each color of the process ink. Each version of CMYKLcLm is generated by the processing of the separation printing section 173. When printing is performed on both sides of the print medium PM, the separation printing section 173 generates each of CMYKLcLm plates for the front side and rear side of the print medium PM.

The halftone processing section 175 generates print data by performing a halftone process using the density value of each pixel after the separation process. The printing device 400 receives the print data sent from the halftone processing section 175, and executes printing based on the printing conditions included in the received print data. In a case where printing is performed on both surfaces of the print medium PM, the halftone processing section 175 generates print data for each of the front side and the rear side of the print medium PM.

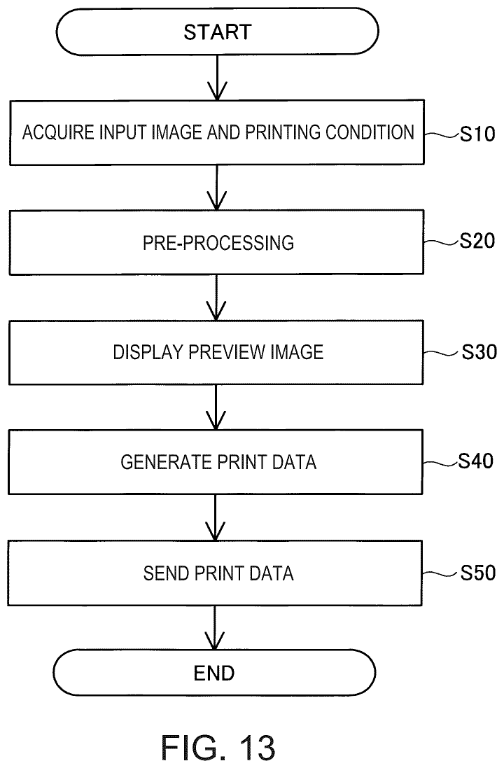

FIG. 13 is a flowchart showing a process related to printing executed in the image processing device 100. The process of FIG. 13 is started, for example, when an operation instruction is received via the user's input device 200.

In step S10, input image data IMi and printing conditions are acquired. Specifically, first, the user interface UI is displayed on the display device 300. Furthermore, image data (input image data IMi) designated by the user through the user interface UI is acquired. In addition, information indicating printing conditions input by the user via the user interface UI is acquired. The process in step S10 is executed by the processor 103, which functions as the image data acquisition section 110 and the printing condition acquisition section 130.

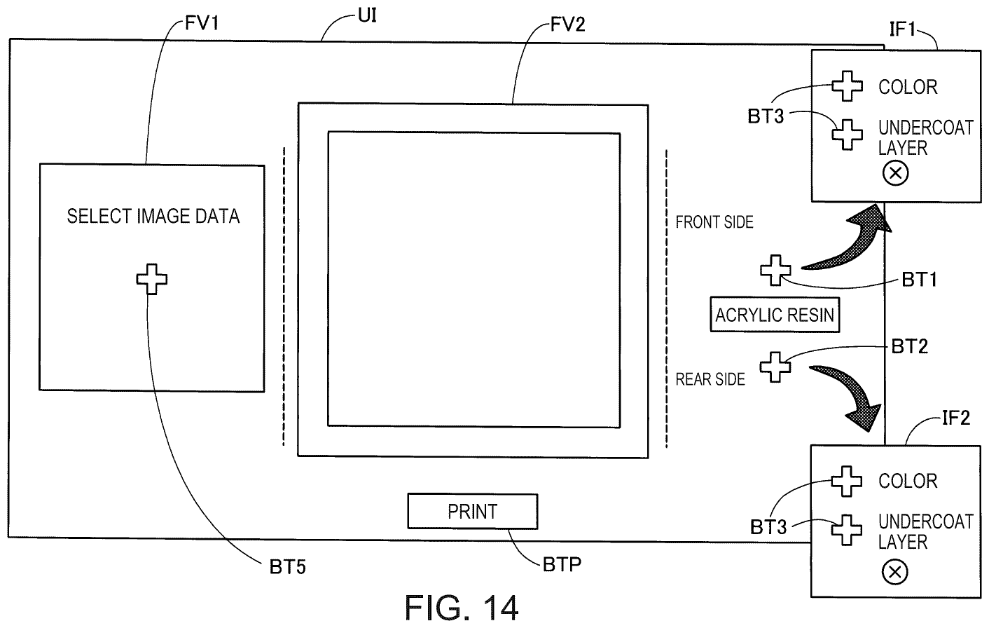

FIG. 14 is an explanatory diagram showing an example of a user interface UI for inputting image data. The user interface UI is displayed on the display device 300 under the control of the processor 103. Here, an example in which an acrylic plate is used as the print medium PM will be described.

The user interface UI includes a display region FM for displaying the type of print medium PM, a button BT1 for adding a print layer to be laminated on the front side of the print medium PM, a button BT2 for adding a print layer to be laminated on the rear side of the print medium PM, a display region FV1 for displaying an image selected by the user, a display region FV2 for displaying the preview image, and a print button BTP for instructing the start of printing.

When the user taps the button BT1, input form IF1 is displayed. The input form IF1 is used to add a print layer to be arranged on the front side of the acrylic plate as the print medium PM. In the input form IF1, a color layer and an undercoat layer can be selected. The user can add a desired print layer by tapping button BT3.

When the user taps button BT2, input form IF2 is displayed. The input form IF2 is used to add a print layer to be arranged on the rear side of an acrylic plate as the print medium PM. In input form IF2, a color layer and an undercoat layer can be selected. The user can add a desired print layer by tapping button BT3.

As shown in FIG. 13, in step S20, pre-processing is executed by each section of the pre-process section 150. The content of the pre-processing is as shown in FIG. 11. Through the pre-processing, the device color image data IMd, the specific color image data IMt, the rendering image data IMm, the rendering specific color image data IMmt, and the rendering medium color Clp are generated. The device color image data IMd and the specific color image data IMt are sent to the print data generating section 170. The rendering image data IMm, the rendering specific color image data IMmt, and the rendering medium color Clp are sent to the rendering section 160. When no undercoat layer is added in the user interface UI, the specific color image data IMt and the rendering specific color image data IMmt are not generated.

In step S30, the rendering image generated by the rendering section 160 is displayed on the display device 300 as the preview image. The processing of the rendering section 160 is as shown in FIG. 12.

In step S40, the print data is generated by the print data generating section 170. In a case where rear side printing is designated, the setting section 171 executes the horizontal inversion processing of the image. When the device color image data IMd and the specific color image data IMt are supplied from the pre-process section 150, the setting section 171 performs the horizontal inversion process on each of the device color image data IMd and the specific color image data IMt. When only the device color image data IMd is supplied from the pre-process section 150, the setting section 171 performs the horizontal inversion process on the device color image data IMd. The setting section 171 changes the stacking order when it is designated to overlap a plurality of print layers in the case of rear side printing. In the case of front side printing, an undercoat layer and a color layer are laminated in this order, starting from the side closest to the front side of the print medium. In the case of rear side printing, a color layer and an undercoat layer are laminated in this order, starting from closest to the rear side of the print medium.

The separation printing section 173 creates each color plate of CMYKLcLm, and the specific color plate if it is needed. The halftone processing section 175 generate the print data by performing halftone processing. In step S50, the print data is sent to the printing device 400. The above is a series of processes relating to printing executed in the image processing device 100.

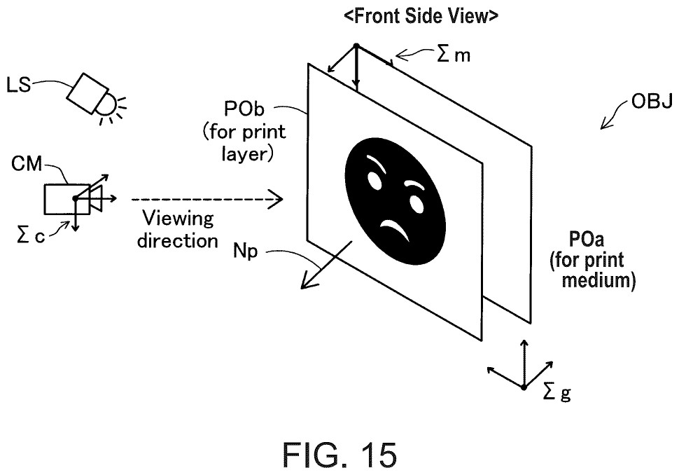

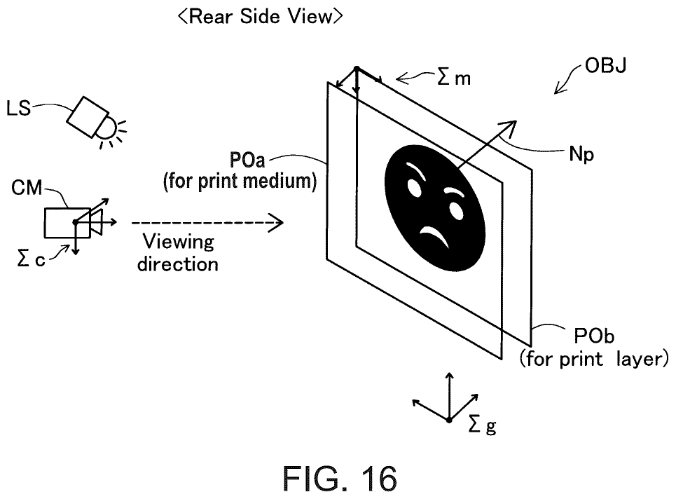

In the present embodiment, the image processing device 100 displays a rendering image as the preview image. FIG. 15 is an explanatory diagram schematically showing a state in which the front side of a printed matter represented as a 3D object in the virtual space is observed. FIG. 16 is an explanatory diagram schematically illustrating a state in which the rear side of the printed matter represented as a 3D object in the virtual space is observed. Here, as shown in FIG. 2, an example of printed matter printed on the front side of the print medium PM by front side printing is shown. The printed matter is represented as a 3-Dimensional Object (3D object) OBJ. The 3D object OBJ includes a polygon object POa for rendering the print medium PM and a polygon object POb for rendering the print layer.

Two polygon objects POa and POb are arranged in parallel.

The direction of the normal line vector Np of the polygon object POa is toward the front side of the 3D object OBJ. The 3D object OBJ is illuminated by the light source LS. In FIGS. 15 and 16, the line of sight of the camera CM is indicated by a dashed arrow. In the rendering process, the 3D object OBJ is treated as a transparent object. In FIGS. 15 and 16, for the sake of convenience, the distance between the two polygon objects POa and POb is depicted to be large, but in actuality, in the virtual space, the distance between polygon objects POa and POb is a very short distance to the extent that Z-fighting does not occur. Further, in the virtual space, the thickness of the polygon object POa representing the print medium PM reflects the thickness of the print medium PM, and the thickness of the polygon object POb representing the print layer is substantially zero.

In FIGS. 15 and 16, coordinate systems used for the rendering process are depicted, including the local coordinate system Σm (also referred to as a model coordinate system), which is a three-dimensional orthogonal coordinate system of the 3D object OBJ, the world coordinate system Σg (also referred to as a global coordinate system), which is a three-dimensional orthogonal coordinate system of the virtual space, and the view coordinate system Σc (also referred to as a camera coordinate system), which is a three-dimensional orthogonal coordinate system of the camera CM arranged in the virtual space. In the rendering process, another coordinate system such as a screen coordinate system, which is the coordinate system of a screen onto which a scene viewed from camera CM is projected, is also used, but is omitted in FIGS. 15 and 16.

As shown in FIG. 15, with respect to the state in which the front side of the 3D object OBJ is oriented in the viewing direction of the camera CM, a front side view obtained by observing the front side of the 3D object OBJ through the camera CM is generated as a rendering image.

As shown in FIG. 16, with respect to the state where the viewing direction of the camera CM is directed to the rear side of the 3D object OBJ, a rear side view in which the rear side of the 3D object OBJ is observed through the camera CM is generated as the rendering image.

Each of the polygon objects POa and POb may be formed of one polygon. Alternatively, the polygon objects POa and POb may each be configured by plural small polygons. If the polygon object is composed of a plurality of polygons, it is possible to easily generate not only the rendering image of a flat printed matter but also the rendering image of a curved printed matter.

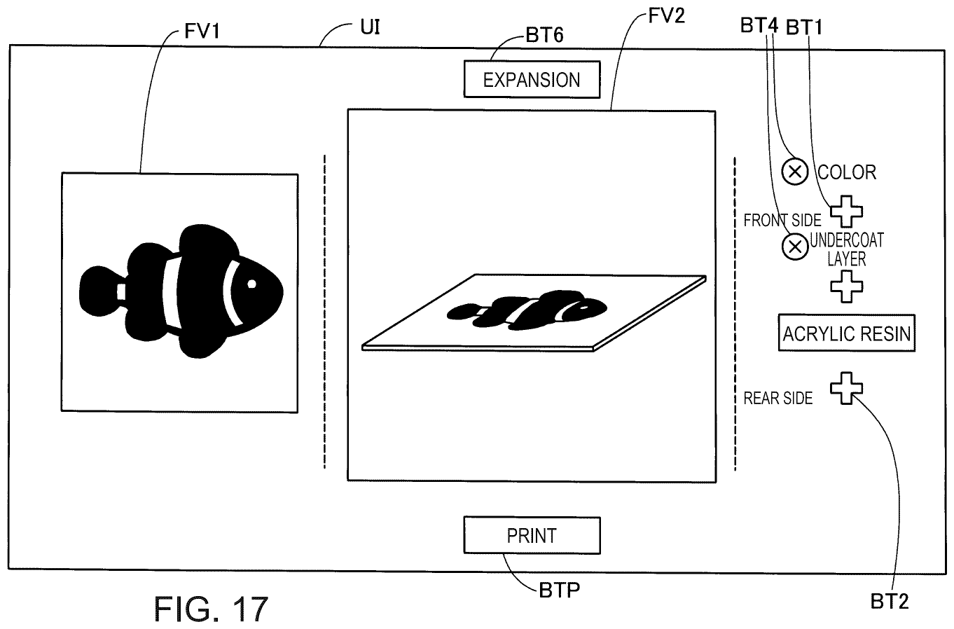

FIG. 17 is an explanatory diagram of a user interface UI on which the preview image is displayed. FIG. 17 illustrates the user interface UI representing a state after the user selects the image data and adds the color layer and the undercoat layer. In the illustrated example, an image represented by the selected image data is displayed in the display region FV1. The color layer and the undercoat layer are added to the front side of the acrylic plate as the print medium PM.

On the user interface UI, a button BT4 for deleting each color layer added by the user is displayed. The user can delete the added the color layer or the undercoat layer by tapping button BT4.

The preview image is displayed in the display region FV2. A rendering image representing a state in which one or more 3D objects corresponding to one or more print layers and the virtual 3D objects corresponding to a print medium are superimposed in a designated stacking order is displayed as the preview image in the display region FV2. In the present embodiment, it is assumed that the preview image of printed matter viewed from a predetermined position in a predetermined viewing direction is displayed in the display region FV2.

The image processing device 100 according to the present embodiment can display, on the display device 300, a preview image in which the 3D objects corresponding to respective elements constituting printed matter are separated in response to a user's operation instruction. As described above, the display device 300 has a function as a pointing device. The user can give an instruction to switch the display of the preview image by performing a touch operation on the image displayed on the display device 300. The instruction to switch the display of the preview image is also referred to as an “instruction related to the display mode”.

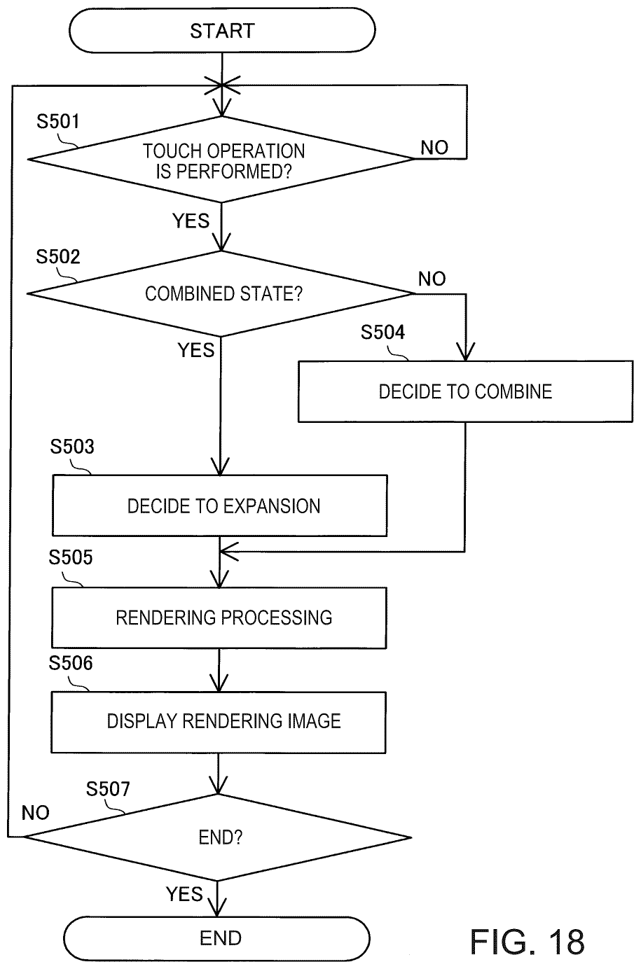

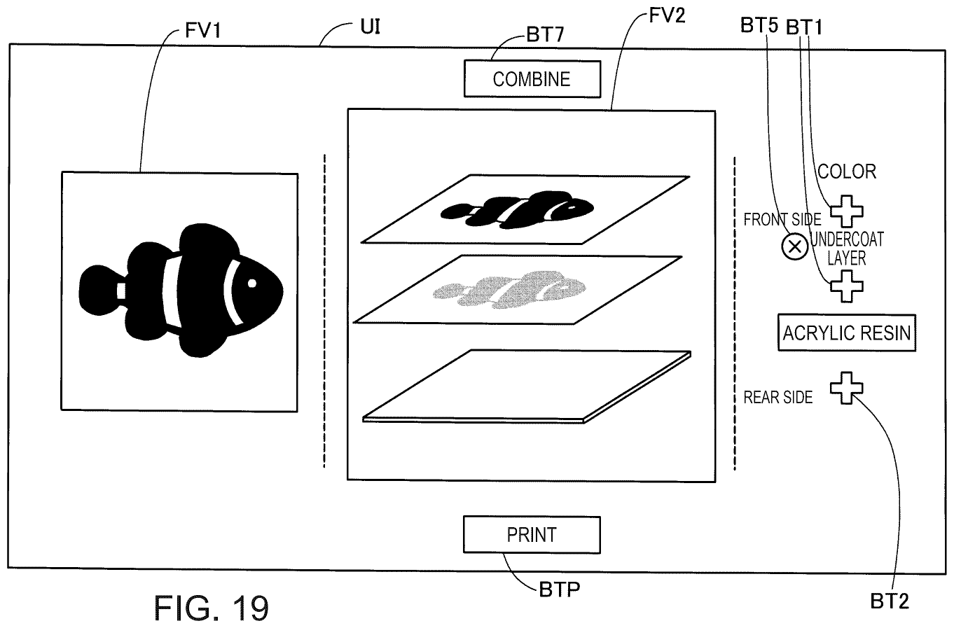

FIG. 18 is a flowchart showing a switching process of a preview image display. FIG. 19 is an explanatory diagram showing the user interface UI. The process illustrated in FIG. 18 is executed by the processor 103 functioning as the pre-process section 150, the rendering section 160, and the update reception section 165. In step S501, it is determined whether or not a touch operation for instructing display switching has been performed. The touch operation for instructing display switching refers to an operation of touching button BT6 when user interface UI shown in FIG. 17 is displayed. In a case where the user interface UI illustrated in FIG. 19 is displayed, the touch operation for instructing display switching refers to the action of touching button BT7. Details of FIG. 19 will be described later.

In step S502 shown in FIG. 18, it is determined whether the preview image displayed on the user interface UI indicates a state in which respective layers are combined. The combined state refers to a state in which the 3D objects corresponding to the print medium and the 3D objects corresponding to each print layer are combined. The preview image shown in FIG. 17 represents a state in which the respective layers are combined. If it is determined that the layers are combined (step S502: YES), it is decided in step S503 that the respective layers are to be expanded. When the preview image shown in FIG. 17 is displayed, the user taps a button BT6 arranged in the upper part of the display region FV2, thereby giving an instruction to expand respective layers constituting the virtual printed matter displayed in the display region FV2. The button BT6 is used by the user to issue an instruction to expand the 3D object representing printed matter.

As shown in FIG. 18, if it is determined in step S502 that the layers have not been combined, in other words, the respective layers have been expanded (step S502: NO), it is determined in step S504 to combine the layers. The expanded state refers to a state in which the 3D object corresponding to the print medium and each 3D object corresponding to each print layer are stacked in the stacking order with intervals between them. The preview image shown in FIG. 19 represents a state in which layers are expanded. When the preview image shown in FIG. 19 is displayed, the user taps a button BT7 arranged in the upper part of the display region FV2 to instruct to combine the respective layers constituting the virtual printed matter displayed in the display region FV2. The button BT7 is used for the user to instruct the combining of 3D objects representing the respective layers.

In step S505, the rendering process is performed again. When it is determined in step S503 that respective layers are to be expanded, in step S505, the positions at which the 3D objects are arranged are changed so that the distances between the 3D objects corresponding to the print medium and the 3D objects corresponding to the print layers become predetermined intervals. As a result, a rendering image is generated that represents a state in which the 3D object corresponding to the print medium and the 3D objects corresponding to the print layers are stacked in the stacking order with intervals between them. The generated rendering image represents a state in which the print medium and each print layer are expanded.

If it is determined in step S504 that the respective layers are to be combined, in step S505, the positions at which the 3D objects are arranged are changed so that the intervals between the 3D objects corresponding to the print medium and the 3D objects corresponding to the print layers are zero or close to zero. As a result, a rendering image is generated that represents a state in which the 3D object corresponding to the print medium and the 3D objects corresponding to each print layer are stacked in the stacking order and combined with each other.

In step S506, the newly generated rendering image is displayed as a preview image in the display region FV2 of the user interface UI. If it is determined in step S503 that respective layers are to be expanded, a preview image as shown in FIG. 19 is displayed in the display region FV2. If it is determined in step S504 that the respective layers are to be combined, a preview image as shown in FIG. 17 is displayed in the display region FV2.

In step S507, it is determined whether or not to end the process. For example, in a case where the print button BTP is pressed in the user interface UI, it is determined that the process is ended. If it is determined that the process is to be terminated (step S507: YES), the process shown in FIG. 18 is terminated. When it is determined that the process is continued (step S507: NO), the process of step S501 is executed again. The processing from step S501 to step S507 is repeatedly executed until the print button BTP is pressed.

As described above, in the present embodiment, the preview image representing the expanded printed matter is represented in a mode in which the print medium and the 3D objects representing the respective print layers are stacked with intervals between them. Therefore, when a plurality of print layers is formed, the user can easily recognize each print layer. Further, the user can easily grasp the effect of the overlap of the print layers. For example, it is possible to confirm the appearance of the color layer when the undercoat layer is overlapped and the appearance of the color layer when the undercoat layer is not overlapped, without the need to configure the addition or deletion of the print layer.

Additionally, by toggling the display between the preview image that represents the combined printed matter and the preview image that represents the expanded printed matter according to a user's instructions, the user can thoroughly confirm each print layer or review the entire printed matter. Before printing, it is possible to easily confirm the completion state of the printed matter.

### B. Other Embodiments

### B1. Other Embodiment 1

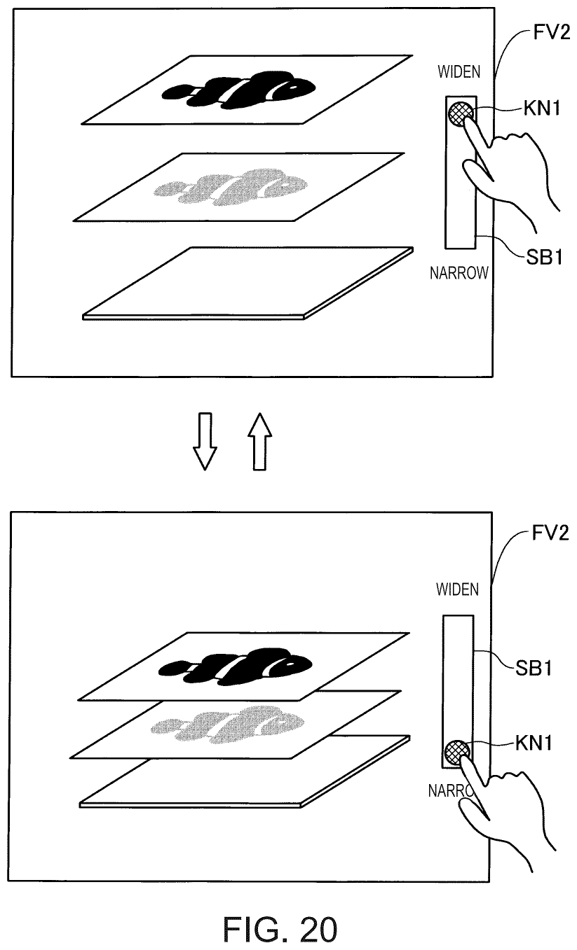

The user may be able to arbitrarily adjust the interval between the printed matter that was expanded. FIG. 20 is an explanatory diagram showing an example of a display mode of a preview image according to an other embodiment 1. In the illustrated example, only the display region FV2 of the user interface UI is shown.

When the expanded printed matter is displayed, a slider bar SB1 is displayed together with the preview image in the display region FV2. The slider bar SB1 is used for the user to instruct the adjustment of the interval between the respective layers. The user can instruct to widen the interval between the respective layers by moving knob KN1 upward. Further, the user can give an instruction to narrow the interval between the respective layers by moving the knob KN1 downward. In response to the operation instruction of the knob KN1, the image processing device 100 executes the rendering process again and updates the display of the preview image. At this time, the interval between the respective layers is adjusted in accordance with the position of knob KN1. Therefore, the user can check any specific print layer in detail. By adjusting the interval between the respective layers, the user can easily confirm the respective layers and the stacking effect of the layers.

Further, when the knob KN1 is moved to the lowermost position, the image processing device 100 may display a preview image of the printed matter in the combined state.

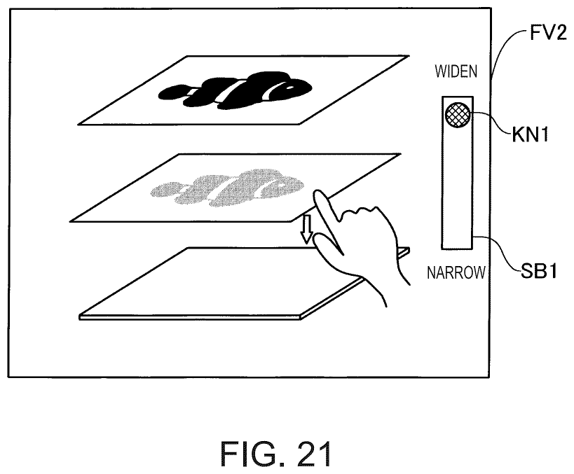

Although FIG. 20 shows an example in which the respective layers are arranged at equal intervals, the respective layers may be arranged at unequal intervals. FIG. 21 is an explanatory diagram illustrating another example of a display mode of a preview image according to the other embodiment 1. For example, when the user drags only a desired layer, the position of only the corresponding layer may be changed. In response to the operation instruction, the image processing device 100 executes the rendering process again and updates the display of the preview image. FIG. 21 illustrates an example in which the position of the undercoat layer is changed by the user dragging the undercoat layer. The user can change the position of a desired layer and can check an arbitrary print layer in detail.

### B2. Other Embodiment 2

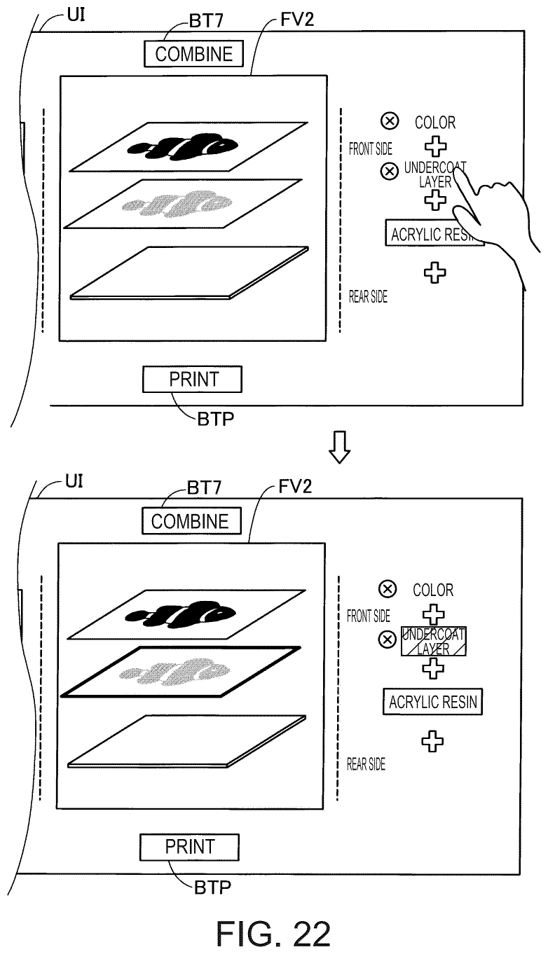

FIG. 22 is an explanatory diagram of an operation of a user interface UI according to an other embodiment 2. As shown in the upper part of FIG. 22, the user can emphasize and display a desired print layer in the preview image by tapping the desired print layer on the user interface UI. In response to the operation instruction, the image processing device 100 executes the rendering process again and updates the display of the preview image. The instruction by the operation of tapping the print layer to display the desired print layer in an emphasized manner is also referred to as an “emphasized display instruction”. In the lower part of FIG. 22, the user interface UI in which the selected undercoat layer is emphasized is shown. When a plurality of print layers is stacked, the user can easily recognize the print layer of interest.

In addition, the user can return the emphasized print layer to normal display (display without emphasizing) by tapping the print layer selected in the user interface UI again. In response to the operation instruction, the image processing device 100 executes the rendering process again and updates the display of the preview image.

### B3. Other Embodiment 3

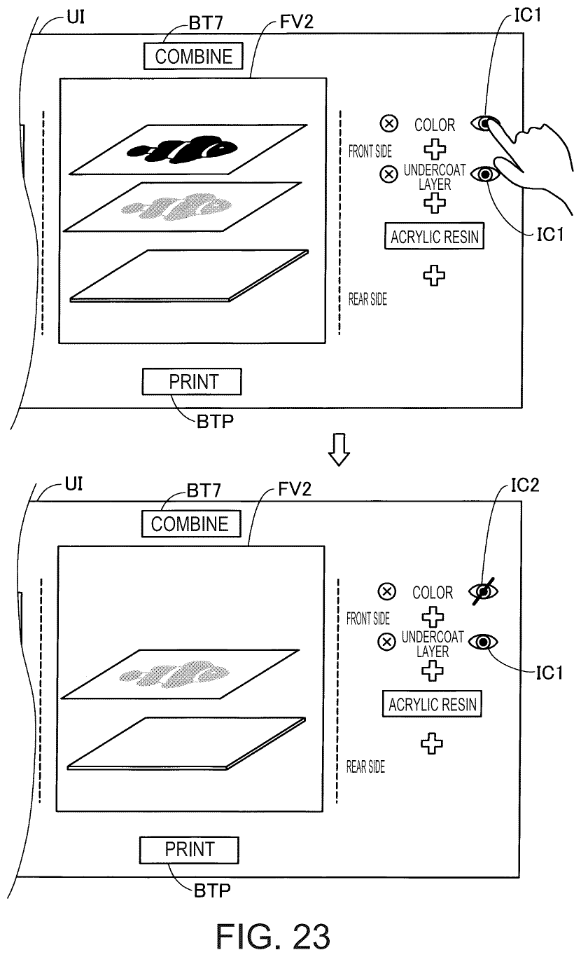

FIG. 23 is an explanatory diagram of an operation of a user interface UI according to an other embodiment 3. In the illustrated example, an icon IC1 or an icon IC2 for display switching corresponding to respective layers are displayed on the user interface UI. As shown in the upper part of FIG. 23, the user can cause the desired print layer not to be displayed in the preview image by tapping the icon IC1 for display switching for the desired print layer in the user interface UI. In response to the operation instruction, the image processing device 100 executes the rendering process again and updates the display of the preview image. An instruction given by tapping the icon IC1 for display switching is also referred to as a “non-display instruction”. In the lower part of FIG. 23, the user interface UI is displayed where the selected color layer is not displayed. Further, an icon IC2 indicating that the color layer is not displayed is displayed. Since a desired print layer can be hidden, for example, the user can easily check other print layers arranged below the hidden print layer. In addition, the user can display the print layer again by tapping the icon IC2 for display switching for the print layer selected in the user interface UI. In response to the operation instruction, the image processing device 100 executes the rendering process again and updates the display of the preview image.

The user can enlarge and display the 3D object in the preview image by performing a pinch-out operation on the 3D object representing a desired print layer in the user interface UI. In response to the operation instruction, the image processing device 100 executes the rendering process again and updates the display of the preview image. The user can shrink and display the 3D object in the preview image by performing a pinch-in operation on the 3D object representing a desired print layer in the user interface UI. The instruction by the pinch-out operation is also referred to as an “instruction related to enlarged display”. The instruction by the pinch-in operation is also referred to as an “instruction related to reduced display”. In response to the operation instruction, the image processing device 100 executes the rendering process again and updates the display of the preview image. By displaying a part of the print layers in an enlarged manner, the user can check a desired print layer in detail.

### B4. Other Embodiment 4

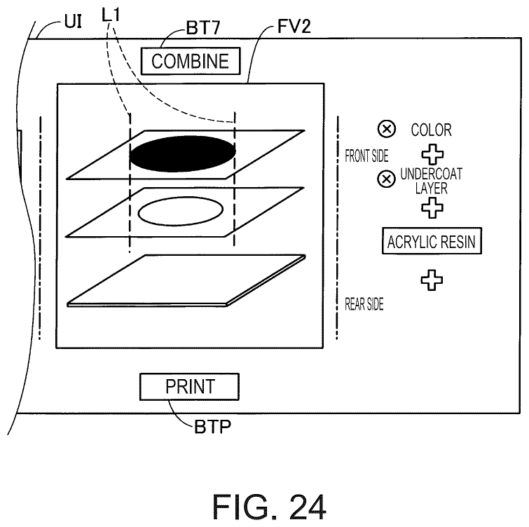

FIG. 24 is an explanatory diagram of an operation of a user interface UI according to an other embodiment 4. The additional line L1 may be displayed on the preview image displayed in the display region FV2 of the user interface UI. In the illustrated example, straight lines that pass through parts of the outline of the color layer and that are perpendicular to the color layer are displayed as additional lines L1. In the preview image, the 3D object representing the color layer and the 3D object representing the undercoat layer are parallel to each other. It is desirable that two or more additional lines L1 are displayed. In order to prevent the undercoat layer from protruding due to misalignment or bleeding during printing, the range of the undercoat layer may be made narrower than the range of the color layer. Since two or more additional lines L1 are displayed in the preview image, the user can easily check the degree of overlap between the color layer and the undercoat layer. The color layer is also referred to as a “first print layer”. The undercoat layer is also referred to as a “second print layer”. The image formed by the color layer is also referred to as a “first image”. The undercoat formed by the undercoat layer is also referred to as a “second image”.

### C. Other Embodiments

The present disclosure is not limited to the above described embodiments and can be realized by various configurations without departing from the scope of the present disclosure. For example, the technical features in the embodiments corresponding to the technical features in the aspects described in the summary of the disclosure can be replaced or combined as appropriate in order to solve some or all of the problems described above or in order to achieve some or all of the effects described above. If the technical features are not described as essential in this specification, the technical features can be appropriately omitted.

(1) According to a first aspect of the present disclosure, an image processing method is provided. The image processing method includes a step (a) of receiving a stacking order of a print medium and one or more print layers to be stacked on the print medium by printing on the print medium; a step (b) of displaying a preview image on a display device, the preview image representing a state of one or more virtual three dimensional objects that correspond to the one or more print layers and a three dimensional object that corresponds to the print medium superimposed and combined in the stacking order, the preview image corresponding to appearance in a three dimensional virtual space; a step (c) of displaying a preview image on the display device, the preview image representing the state of the one or more three dimensional objects corresponding to the one or more print layers and the three dimensional object corresponding to the print medium stacked in the stacking order with intervals therebetween, the preview image corresponding to appearance in the virtual space; and a step (d) for receiving an instruction to execute one of step (b) and step (c), and executing the instructed one of step (b) and step (c).

According to the aspect described above, the preview image of the printed matter is displayed in a mode in which the print medium and the three dimensional objects representing the respective print layers are stacked on each other with intervals between them. Therefore, when a plurality of print layers is formed, the user can easily recognize each print layer.

(2) The image processing method of the above aspect may further include: a step (e) of, when a change instruction to change the interval is received while the preview image is being displayed by execution of step (c), displaying, on the display device, the preview image representing the one or more three dimensional objects corresponding to the one or more print layers and a state in which the interval between the three dimensional objects with respect to the print medium is changed in accordance with the change instruction.

According to the aspect, in a case where a plurality of print layers is overlapped, the user can check an arbitrary print layer in detail.

(3) The image processing method of the above-described aspect may further include a step (f) of, when an emphasized display instruction for instructing emphasized display of a selected print layer is received while the preview image is being displayed by execution of step (c), displaying, on the display device, the preview image in which the three dimensional object corresponding to the selected print layer is displayed in an emphasized manner.

According to the aspect, in a case where a plurality of print layers is overlapped, the user can easily recognize the print layer to which attention is paid.

(4) The image processing method of the above aspect may further include: a step (g) of, when the one or more print layers include a first print layer and a second print layer superimposed on the first print layer, and a first image formed by the first print layer includes a second image formed by the second print layer, projecting at least a part of an outline of the first image onto the second print layer by displaying an additional line which is a straight line that passes through at least the part of the outline of the first image and that is perpendicular to the first print layer in a range of the at least the part.

(5) The image processing method of the above aspect may further include: a step (h) of, when a non-display instruction for a selected print layer is received while the preview image is being displayed by execution of step (c), displaying, on the display device, the preview image with the three dimensional object corresponding to the selected print layer not shown.

According to the above-described aspect, in a case where a plurality of print layers is overlapped with each other, by hiding a part of the print layers, for example, it is easy to check another print layer disposed under the hidden print layer.

(6) The image processing method of the above aspect may further include a step (i) of, when an instruction related to an enlarged display or a reduced display of a selected print layer is received while the preview image is being displayed by execution of step (c), displaying, on the display device, the preview image in which the three dimensional object corresponding to the selected print layer is displayed in an enlarged or a reduced manner.

According to the aspect, the user can check a desired print layer in detail by displaying a part of the print layers in an enlarged manner.

(7) According to a second aspect of the present disclosure, an image processing device is provided. The image processing device includes a print setting reception section that receives a stacking order of a print medium and one or more print layers to be printed on a print medium and a display processing section that configured to display, on a display device, a preview image representing one or more virtual three dimensional objects representing printed matter, the preview image corresponding to an appearance in a three dimensional virtual space. In accordance with an instruction received relating to display mode, the display processing section displays, on the display device, the preview image representing the one or more three dimensional objects corresponding to the one or more print layer layers and a state of the three dimensional objects superimposed and combined in the stacking order with respect to the print medium, the preview image corresponding to how the preview image appears in a three dimensional virtual space or displays, on the display device, the preview image representing the one or more three dimensional objects corresponding to the one or more print layers and the state of the three dimensional objects stacked in the stacking order with intervals between them with respect to the print medium, the preview image corresponding to how the preview image appears in the virtual space.

According to the aspect described above, the preview image of the printed matter is displayed in a mode in which the print medium and the three dimensional objects representing the respective print layers are stacked on each other with intervals between them. Therefore, when a plurality of print layers is formed, the user can easily recognize each print layer.

(8) According to a third aspect of the present disclosure, a printing system is provided. The printing system includes an image processing device, a printing device, and a display device. The image processing device includes: a print setting reception section that receives a stacking order of a print medium and one or more print layers to be printed on a print medium and a display processing section configured to display, on the display device, a preview image representing one or more virtual 1 three dimensional objects representing printed matter, the preview image corresponding to how the printed matter appears in a three dimensional virtual space. In accordance with an instruction received relating to display mode, the display processing section displays, on the display device, the preview image representing the one or more three dimensional objects corresponding to the one or more print layer layers and a state of the three dimensional objects superimposed and combined in the stacking order with respect to the print medium, the preview image corresponding to how the preview image appears in a three dimensional virtual space or displays, on the display device, the preview image representing the one or more three dimensional objects corresponding to the one or more print layers and the state of the three dimensional objects stacked in the stacking order with intervals between them with respect to the print medium, the preview image corresponding to how the preview image appears in the virtual space.

According to the aspect described above, the preview image of the printed matter is displayed in a mode in which the print medium and the three dimensional objects representing the respective print layers are stacked on each other with intervals between them. Therefore, when a plurality of print layers is formed, the user can easily recognize each print layer.

(9) According to a fourth aspect of the present disclosure, an image processing program is provided. The image processing program is realized by a computer and includes: a function (a) for receiving a stacking order of a print medium and one or more print layers to be printed on a print medium; a function (b) for displaying, on a display device, a preview image representing one or more virtual three dimensional objects corresponding to one or more print layers and a state of the three dimensional objects superimposed and combined in the stacking order with respect to the print medium, the preview image corresponding to how the preview image appears in a three dimensional virtual space; a function (c) for displaying, on the display device, the preview image representing the one or more three dimensional objects corresponding to the one or more print layers and the state of the three dimensional objects stacked in the stacking order with intervals between them with respect to the print medium, the preview image corresponding to how the preview image appears in the virtual space; and a function (d) for receiving an instruction to execute one of the function (b) and the function (c), and executing the instructed one of the function (b) and the function (c).

According to the aspect described above, the preview image of the printed matter is displayed in a mode in which the print medium and the three dimensional objects representing the respective print layers are stacked on each other with intervals between them. Therefore, when a plurality of print layers is formed, the user can easily recognize each print layer.

What is claimed is:

1. An image processing method comprising:
a step (a) of receiving a stacking order of a print medium and one or more print layers to be stacked on the print medium by printing on the print medium;
a step (b) of displaying a preview image on a display device, the preview image representing a state of one or more virtual three dimensional objects that correspond to the one or more print layers and a three dimensional object that corresponds to the print medium superimposed and combined in the stacking order, the preview image corresponding to appearance in a three dimensional virtual space;
a step (c) of displaying a preview image on the display device, the preview image representing the state of the one or more three dimensional objects corresponding to the one or more print layers and the three dimensional object corresponding to the print medium stacked in the stacking order with intervals therebetween, the preview image corresponding to appearance in the virtual space; and
a step (d) for receiving an instruction to execute one of step (b) and step (c), and for executing the instructed one of step (b) and step (c).

2. The image processing method according to claim 1, further comprising:
a step (e) of, when a change instruction to change the interval is received while the preview image is being displayed by execution of step (c), displaying, on the display device, the preview image representing the one or more three dimensional objects corresponding to the one or more print layers and a state in which the interval between the three dimensional objects with respect to the print medium is changed in accordance with the change instruction.

3. The image processing method according to claim 1, further comprising:
a step (f) of, when an emphasized display instruction for instructing emphasized display of a selected print layer is received while the preview image is being displayed by execution of step (c), displaying, on the display device, the preview image in which the three dimensional object corresponding to the selected print layer is displayed in an emphasized manner.

4. The image processing method according to claim 1, further comprising:
a step (g) of, when the one or more print layers include a first print layer and a second print layer superimposed on the first print layer, and a first image formed by the first print layer includes a second image formed by the second print layer, projecting at least a part of an outline of the first image onto the second print layer by displaying an additional line which is a straight line that passes through at least the part of the outline of the first image and that is perpendicular to the first print layer in a range of the at least the part.

5. The image processing method according to claim 1, further comprising:
a step (h) of, when a non-display instruction for a selected print layer is received while the preview image is being displayed by execution of step (c), displaying, on the display device, the preview image with the three dimensional object corresponding to the selected print layer not shown.

6. The image processing method according to claim 1, further comprising:
a step (i) of, when an instruction related to an enlarged display or a reduced display of a selected print layer is received while the preview image is being displayed by execution of step (c), displaying, on the display device, the preview image in which the three dimensional object corresponding to the selected print layer is displayed in an enlarged or a reduced manner.

7. An image processing device comprising:
a print setting reception section that receives a stacking order of a print medium and one or more print layers to be printed on a print medium and
a display processing section configured to display, on a display device, a preview image representing one or more virtual three dimensional objects representing a printed matter, the preview image corresponding to an appearance in a three dimensional virtual space, wherein
in accordance with an instruction received relating to display mode, the display processing section displays, on the display device, the preview image representing the one or more three dimensional objects corresponding to the one or more print layer layers and a state of the three dimensional objects superimposed and combined in the stacking order with respect to the print medium, the preview image corresponding to how the preview image appears in a three dimensional virtual space or
displays, on the display device, the preview image representing the one or more three dimensional objects corresponding to the one or more print layers and the state of the three dimensional objects stacked in the stacking order with intervals between them with respect to the print medium, the preview image corresponding to how the preview image appears in the virtual space.

8. A printing system comprising:
an image processing device;
a printing device; and
a display device, wherein
the image processing device includes
a print setting reception section that receives a stacking order of a print medium and one or more print layers to be printed on a print medium and
a display processing section configured to display, on the display device, a preview image representing one or more virtual three dimensional objects representing printed matter, the preview image corresponding to how the printed matter appears in a three dimensional virtual space, and
in accordance with an instruction received relating to display mode, the display processing section displays, on the display device, the preview image representing the one or more three dimensional objects corresponding to the one or more print layer layers and a state of the three dimensional objects superimposed and combined in the stacking order with respect to the print medium, the preview image corresponding to how the preview image appears in a three dimensional virtual space or
displays, on the display device, the preview image representing the one or more three dimensional objects corresponding to the one or more print layers and the state of the three dimensional objects stacked in the stacking order with intervals between them with respect to the print medium, the preview image corresponding to how the preview image appears in the virtual space.

9. A non-transitory computer-readable storage medium storing an image processing program, the image processing program comprising:
a function (a) for receiving a stacking order of a print medium and one or more print layers to be printed on a print medium;
a function (b) for displaying, on a display device, a preview image representing one or more virtual three dimensional objects corresponding to one or more print layers and a state of the three dimensional objects superimposed and combined in the stacking order with respect to the print medium, the preview image corresponding to how the preview image appears in a three dimensional virtual space;
a function (c) for displaying, on the display device, the preview image representing the one or more three dimensional objects corresponding to the one or more print layers and the state of the three dimensional objects stacked in the stacking order with intervals between them with respect to the print medium, the preview image corresponding to how the preview image appears in the virtual space; and
a function (d) for receiving an instruction to execute one of the function (b) or the function (c), and executing the instructed one of the function (b) or the function (c).
